(19) United States
(12) Patent Application Publication
(10) Pub. No.: US 2023/0366192 A1
(43) Pub. Date: Nov. 16, 2023

(54) SEWER CLEANOUT CAP

(71) Applicants: BGA Technology LLC, Holbrook, NY (US); PIPELOGIX LMS, INC., Long Beach, NY (US)

(72) Inventors: Saikumar Padmanabhan, Selden, NY (US); Srinivas Sridhar, Flushing, NY (US); Eliot Bloom, West Islip, NY (US); Michael Bloom, Hoboken, NJ (US); Thomas W. Alfano, East Rockaway, NY (US)

(21) Appl. No.: 18/195,556

(22) Filed: May 10, 2023

Related U.S. Application Data
(60) Provisional application No. 63/340,574, filed on May 11, 2022.

(51) Int. Cl. E03F 3/04

(52) U.S. Cl. CPC E03F 3/04; H01Q 1/2208

(57) ABSTRACT

A sewer cleanout cap includes a body portion, a window plug removably coupled to the body portion, and a radio-frequency identification (RFID) tag. The sewer cleanout cap is on a sewer drain cleanout. The window plug is configured to enable a user to check sewer drainage. The RFID tag is disposed on the body portion of the sewer cleanout cap and is configured to transmit a return signal when energized.

### CROSS-REFERENCE TO RELATED APPLICATION/CLAIM OF PRIORITY

This application claims the benefit of, and priority to, U.S. Provisional Patent Application No. 63/340,574, filed on May 11, 2022, the entire contents of which are hereby incorporated herein by reference.

### TECHNICAL FIELD

The present disclosure relates to piping systems such as sewer systems. More specifically, the present disclosure relates to smart cleanout caps providing instant access to information pertaining to piping systems.

### BACKGROUND

Cleanout caps enable access to internal conduits of pipes, for example, of sewer systems. Since these pipes are typically formed of opaque materials, the cleanout cap must be removed to determine if these conduits need to be cleaned. Moreover, the maintenance history of the conduits is often not readily available. Thus, even if a sewer system does not need cleaning, the cleanout cap would be required to be removed to make such a determination. This process may be tedious and inefficient. Further, when removing a cleanout cap, raw sewage may spill on the ground, creating an environmental issue.

### SUMMARY

The present disclosure provides a sewer cleanout cap that may help make cleaning of sewer systems more efficient and more environmentally friendly.

In accordance with aspects of this disclosure, a sewer cleanout cap includes a body portion, a window plug removably coupled to the body portion, and a radio-frequency identification (RFID) tag. The body portion is configured to be disposed on a sewer drain cleanout. The window plug is configured to enable a user to check sewer drainage. The RFID tag is disposed on the body portion and is configured to transmit a return signal when energized.

In an aspect of the present disclosure, the RFID tag may store a unique identifier (UID). The UID may enable access to information relating to the sewer drain cleanout.

In another aspect of the present disclosure, the information relating to the sewer drain cleanout may include an installation date of the sewer cleanout cap, a cleanout and maintenance history, and/or a location thereof.

In yet another aspect of the present disclosure, the body portion may include lead and/or cast iron.

In a further aspect of the present disclosure, the body portion may include threads.

In yet a further aspect of the present disclosure, the window plug may be formed in the body portion.

In an aspect of the present disclosure, the window plug may include a window made of glass. The window may enable visibility and/or access into the sewer drain cleanout.

In yet another aspect of the present disclosure, the window plug may include a gasket to seal the sewer cleanout cap to the sewer drain cleanout.

In accordance with aspects of the disclosure, a computer-implemented method for using a sewer cleanout cap includes generating an energizing signal for a radio-frequency identification (RFID) tag by an RFID reader, the RFID tag disposed on a body portion of the sewer cleanout cap, wherein the sewer cleanout cap is coupled to a sewer drain cleanout; receiving a return signal from the RFID tag by the RFID reader; and determining a maintenance action for the sewer drain cleanout based on the return signal.

In a further aspect of the present disclosure, the maintenance action may be performed without removing the sewer cleanout cap.

In yet a further aspect of the present disclosure, the method may include transmitting information to a display of the RFID reader to display information relating to the RFID tag; and modifying the displayed information via the RFID reader.

In an aspect of the present disclosure, the RFID reader may be a mobile device.

In accordance with aspects of the disclosure, a system for using a sewer cleanout cap may include a body portion, a window plug removably coupled to the body portion, a radio-frequency (RFID) tag, a processor, and a memory. The body portion is configured to be disposed on a sewer drain cleanout. The window plug is configured to enable a user to check sewer drainage. The RFID tag is disposed on the body portion and is configured to transmit a return signal when energized. The memory stores instructions which, when executed by the processor, cause the system to generate an energizing signal for the RFID tag by an RFID reader, the RFID tag disposed on the body portion of the sewer cleanout cap, wherein the sewer cleanout cap is coupled to a sewer drain cleanout; receive the return signal from the RFID tag by the RFID reader; and determine a maintenance action for the sewer drain cleanout based on the return signal.

In another aspect of the present disclosure, the instructions when executed may further cause the system to reprogram the UID of the RFID tag.

In a further aspect of the present disclosure, the instructions when executed may further cause the system to transmit information to a display of the RFID reader to display information relating to the RFID tag; and modify the displayed information via the RFID reader.

Further details and aspects of exemplary aspects of the present disclosure are described in more detail below with reference to the appended figures.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying drawings of which:

FIG. 1 is a diagram illustrating a sewer cleanout cap system including an RFID reader and an RFID tag in accordance with the disclosure;

FIG. 2 is a front perspective view of a sewer cleanout cap of the sewer cleanout cap system of FIG. 1;

FIG. 3 is a perspective view, with parts separated, of the sewer cleanout cap of FIG. 2;

FIG. 4 is a side perspective view of a window plug of the sewer cleanout cap of FIG. 3;

FIG. 5 is a diagram illustrating the RFID reader shown in FIG. 1;

FIG. 6 is a diagram of a controller of the RFID reader shown in FIG. 5; and

FIG. 7 is functional block diagram of a method of using a sewer cleanout cap in accordance with the disclosure.

Further details and exemplary aspects of the disclosure are described in more detail below with reference to the appended figures. Any of the above aspects and aspects of the disclosure may be combined without departing from the scope of the disclosure.

### DETAILED DESCRIPTION

Aspects of the present disclosure are described in detail with reference to the drawings wherein like reference numerals identify similar or identical elements.

In general, the present disclosure relates to a sewer clean out cap. More specifically, the present disclosure relates to a sewer cleanout cap with a window plug and a radio-frequency identification (RFID) tag.

The phrases “in an aspect,” “in aspects,” “in various aspects,” “in some aspects,” or “in other aspects” may each refer to one or more of the same or different aspects in accordance with the present disclosure.

Although the present disclosure will be described in terms of specific aspects, it will be readily apparent to those skilled in this art that various modifications, rearrangements, and substitutions may be made without departing from the spirit of the present disclosure. The scope of the present disclosure is defined by the claims appended hereto. For purposes of promoting an understanding of the principles of the present disclosure, reference will now be made to exemplary aspects illustrated in the drawings, and specific language will be used to describe the same.

Radio-frequency identification (RFID) tags provide real-time data about products with minimal human intervention. RFID tags are advantageous in tough environments because they can withstand exposure to humidity, chemicals, and high temperature fluctuations unlike traditional barcodes. RFID tags are employed in sewer cleanout systems of this disclosure to provide real-time maintenance data of the disclosed sewer systems.

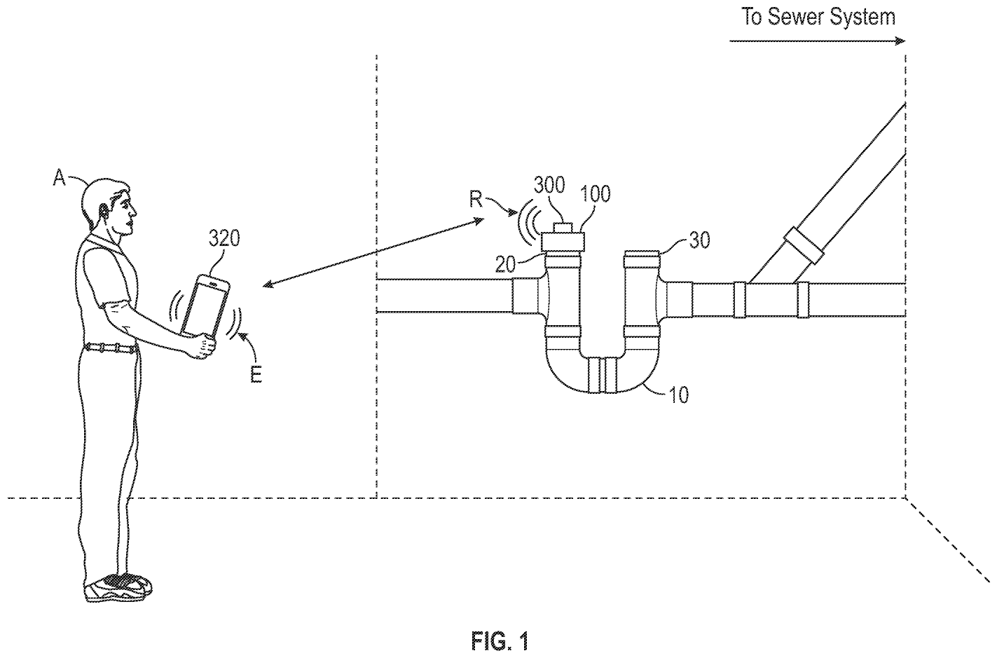

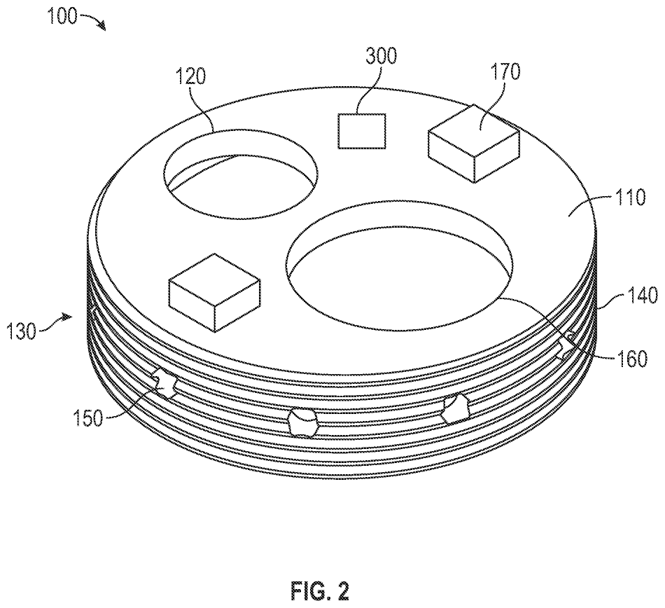

Referring to FIG. 1, a sewer cleanout cap system of this disclosure includes an RFID tag 300 and an RFID reader 320. The RFID tag 300 is configured to interact with an RFID reader 320, which may be controlled by a user A. Referring to FIG. 2, the sewer cleanout cap system includes a sewer cleanout cap 100 containing the RFID tag 300. The sewer cleanout cap 100 secures to a sewer drain cleanout (e.g., “trap”) 10. The sewer cleanout cap 100 additionally contains a body portion 110 and a window plug 200. The RFID tag 300 is configured to transmit a return signal R when energized.

The body portion 110 of the sewer cleanout cap 100 is generally made from the same/similar materials as the sewer drain cleanout 10. The body portion 110 may be made from metals such as lead or cast iron, plastic, composites, and/or alternative durable materials. The body portion 110 may be treated with a corrosion-resistant coating to prevent rusting, such as plasma electrolytic oxidation, chromate conversion coating, painting, or a powder coating. While illustrated with a circular shape, the body portion 110 may include any suitable shape. The body portion 110 supports RFID tag 300 thereon and may include threads 140 (or ribs) formed in an outer rim 130 to enable secure attachment and/or removal from the sewer drain cleanout 10. It is contemplated that the body portion 110 can be secured to sewer drain cleanout 10 by any suitable attachment technique (e.g., snap-fit, friction-fit, fastening, adhesion, etc.). In aspects, the body portion 110 may be secured to the sewer drain cleanout 10 by adding a sealant, for example wax, around the outer rim 130 for providing a watertight seal.

The body portion 110 may include one or more pegs 170 to aid the user A in moving the sewer cleanout cap 100 into or out of sewer drain cleanout 10. For example, the user may hammer the peg 170 to move the sewer cleanout cap 100 into the sewer drain cleanout 10. The outer rim 130 may include one or more holes 150 disposed on outer rim 130. The RFID tag 300 is disposed on the body portion 110 of the sewer cleanout cap 100. Although peg 170 is shown as substantially square, any suitable shape may be used, for example, semicircular.

The sewer drain cleanout 10 may be a U-shaped trap, although the sewer drain cleanout 10 may include any suitable shape. The sewer cleanout cap 100 may be affixed to a first end 20 and/or a second end 30, or any alternative portion of the sewer drain cleanout 10 that is suitable.

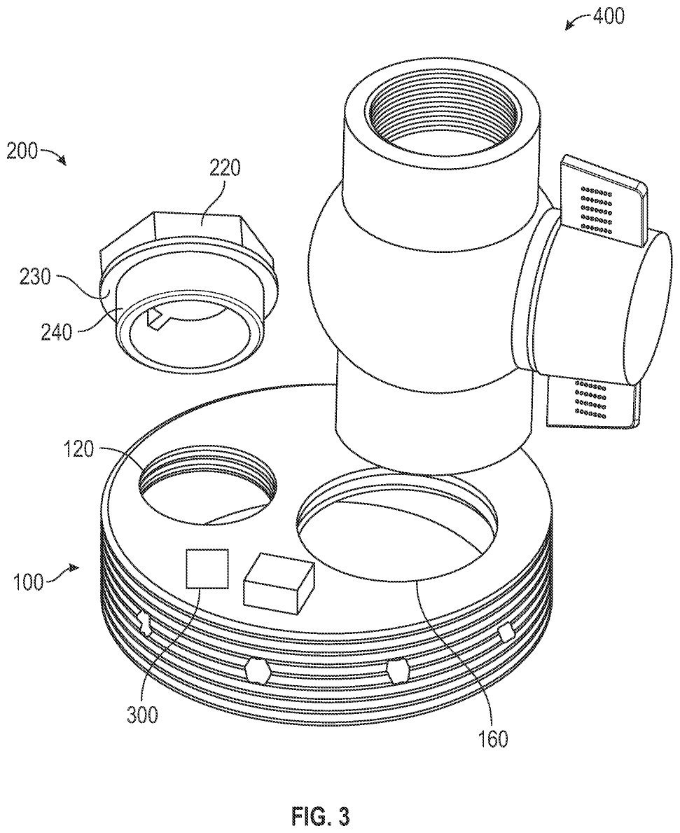

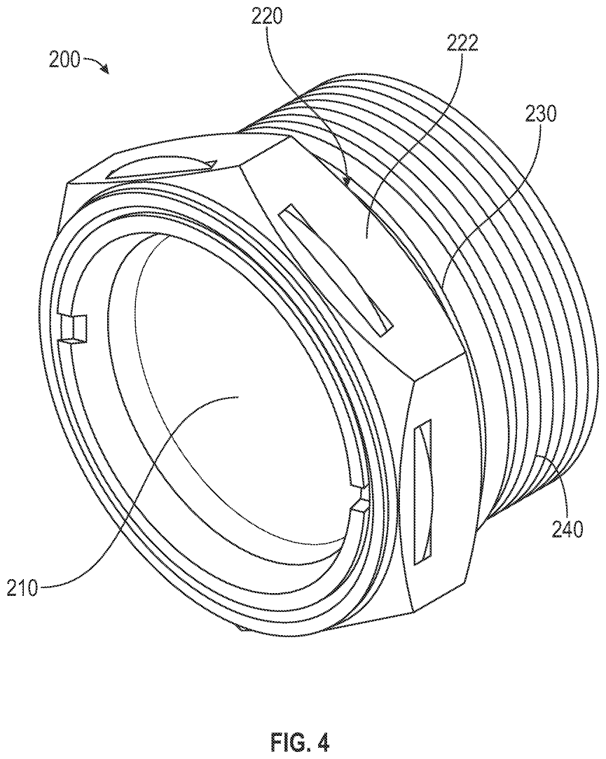

Referring to FIGS. 2-3, the body portion 110 of the sewer cleanout cap 100 defines an opening 120 for supporting the window plug 200 therein. The window plug 200 is configured to enable the user A to check sewer drainage behind the sewer cleanout cap 100. The body portion 110 of the sewer cleanout cap 100 may additionally define an opening 160 to which a valve 400 may be installed. In aspects, the window plug 200 may be disposed at the distal end of the valve 400. Upon opening the valve 400, excess fluid may be drained from the trap or a clogged pipe, or if the window plug 200 is disposed on the end of the valve 400, the user may actuate the valve 400 to check sewer drainage behind the sewer cleanout cap 100. Valve 400 may be any mechanism capable of permitting egress of fluid, such as a ball valve. It is contemplated that the body portion 110 of the sewer cleanout cap 100 may only have opening 160. The valve 400 may be secured to the opening 160, for example, by threading, snap-fit, friction-fit, or any other suitable means.

The window plug 200 generally includes a window 210, a handle portion 220, a gasket 230 and threads 240 (FIG. 3). The opening 120 may be threaded and configured to receive threads 240 of the window plug 200. The threads 240 are located behind the handle portion 220 to enable secure attachment to and/or removal from the body portion 110. While the window plug 200 is illustrated as being removably coupled to the body portion 110, the window plug 200 and body portion 110 may be affixed by any suitable securement technique. For example, the window plug 200 and body portion 110 may be joined by mechanical fasteners such as nut and bolt attachments or may be welded together.

The window 210 of window plug 200 is transparent to enable visibility into the sewer drain cleanout 10. For example, the user A may review sewage status such as clogs without removing the sewer cleanout cap 100 thereby preventing raw sewage from spilling out. The window 210 is removable to enable access into the sewer drain cleanout 10 during maintenance when the sewer cleanout cap 100 cannot be removed. For example, the window 210 may be removed and a drain snake, camera, hose or other device may be inserted through the opening 120. The window 210 may be made from materials such as glass, plastic, composite, and/or roto-molded materials. To ensure durability, any material in the window 210 may be shatterproof or impact resistant. The handle portion 220 is formed around the window 210 and includes edges 222 for the user A to grip onto during maintenance. While illustrated in a hexagonal shape, the handle portion 220 may include any suitable alternative shape. For example, the handle portion 220 may be shaped to fit snugly with a specific shaped wrench or alternative tool to enable ease of removal of the window plug 200. The handle portion 220 may be made from the same/similar material as the body portion 110. The handle portion 220 may be made from metals such as lead or cast iron, plastic, and/or composites. A gasket 230 is located in a space between the handle portion 220 and the sewer drain cleanout 10 to seal cavities and prevent leakage. The gasket 230 may be flexible and made from paper, rubber, silicone, metal, cork, felt, neoprene, nitrile rubber, fiberglass, plastic polymer, and/or the like.

Now referring back to FIG. 1, the RFID tag 300 is disposed on the body portion 110 of the sewer cleanout cap 100. The RFID tag 300 is generally affixed to an outer surface and/or edge of the body portion 110. While the RFID tag 300 may be adhered to any suitable surface of the sewer cleanout cap 100, placement is generally chosen on an outer surface of the body portion 110 to enable accessibility into the sewer drain cleanout 10 and prevent damage due to exposure from raw sewage. The RFID tag 300 may be adhered to the body portion 110 by any suitable method, including film or foam adhesive, epoxy screws/rivets, or embedding methods. For example, an epoxy bonding compound may be used on the RFID tag 300 to ensure strong adherence to the body portion 110, especially when made of metal.

The RFID tag 300 is configured to interact with the RFID reader 320, which generates an energizing signal E for the RFID tag 300. Once energized, the RFID tag 300 is configured to transmit the return signal R. The RFID tag 300 may be a passive RFID system or an active RFID system. Generally, passive RFID systems are used, which do not require a power source or transmitter and therefore are cheaper, smaller, and easier to manufacture than active RFID tags. The RFID tag 300 may operate in low frequency (LF), high frequency (HF), or ultra-high frequency (UHF) bands. LF or HF bands may be used. The LF band covers frequencies from approximately 30 kHz to 300 kHz. The HF band cover frequencies from approximately 3 to 30 MHz and is more sensitive to interference.

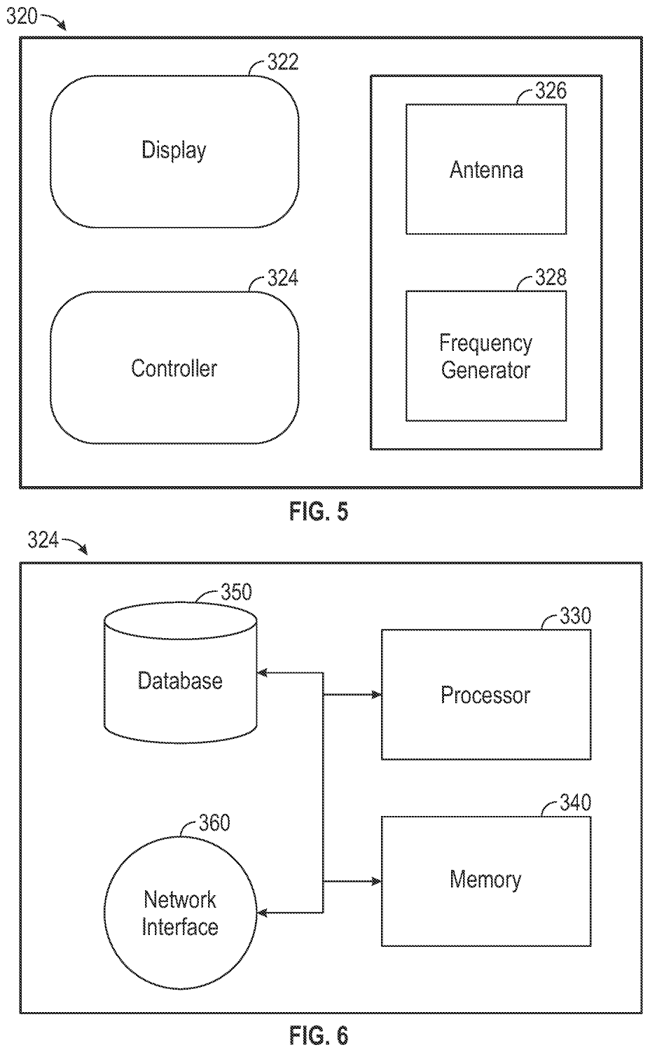

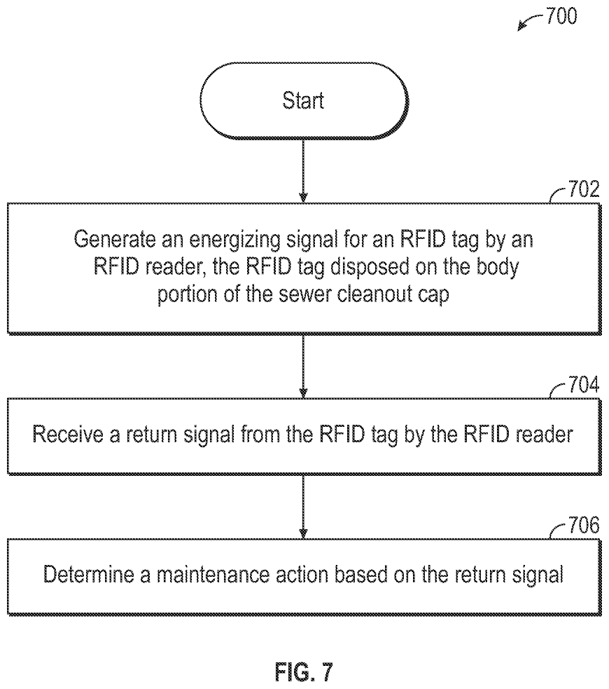

Now referring to FIGS. 5-6, the RFID reader 320 includes a display 322, a controller 324, an antenna 326 and a frequency generator 328. The display 322 may display information relating to the sewer drain cleanout 10. The controller 324 manages interactions between RFID products including reading data, transmitting data, and managing data between any system components. The antenna 326 sends a radio frequency signal to the RFID tag 300 and receives the return signal R from the RFID tag 300, including the UID. The frequency generator 328 generates the corresponding frequency of the signals generated.

With further reference to FIG. 6, the controller 324 generally includes a processor 330, a memory 340, a database 350, and/or a network interface 360. The processor 330 is connected to the memory 340, which is a computer-readable storage medium or memory.

In aspects of the disclosure, the processor 330 may be another type of processor such as a digital signal processor, a microprocessor, an ASIC, a graphics processing unit (GPU), a field-programmable gate array (FPGA), or a central processing unit (CPU).

The memory 340 stores data relating to the sewer drain cleanout 10 and may be a volatile type of memory, e.g., random access memory (RAM), or a non-volatile type of memory, e.g., flash media, disk media, etc. In some aspects of the disclosure, the memory 340 can be separate from the RFID reader 320 and can communicate with the processor 330 through communication buses of a circuit board and/or through communication cables such as serial ATA cables or other types of cables. The memory 340 includes computer-readable instructions that are executable by the processor 330 to operate the RFID reader 320. The database 350 may be used as a storage device for storing/retrieving information relating to the sewer drain cleanout 10, which is keyed by the UID of the RFID 300.

In other aspects of the disclosure, the RFID reader 320 may include the network interface 360 to communicate with other devices or a server. The network interface 360 may also be accomplished in systems that have weights implemented as memristors, chemically, or other inference calculations, as opposed to processors. The disclosed processes may run on the RFID reader 320 or on a user device, including, for example, on a mobile device, an IoT device, or a server system. The user A may be able to review sewer drain cleanout information through a mobile application that interacts with the RFID tag 300, the RFID reader 320, or another device on the network interface 360. For example, the user A may receive an alert on their mobile device when maintenance is required.

Referring to FIG. 5, the disclosure also relates to a method for using the sewer cleanout cap 100. The method includes generating an energizing signal E for the RFID tag 300, receiving the return signal R from RFID tag 300, and determining a maintenance action based on the return signal R.

Initially at step 702, the RFID reader 320 generates the energizing signal E for the RFID tag 300. For example, if the user A is in close proximity to the sewer cleanout cap 100, the user A may use the RFID reader 320 to scan the RFID tag 300, generating the energizing signal E that energizes the RFID tag 300. In aspects, the window 210 may have an ID code etched in the glass, for scanning by a reader.

At step 704, the RFID reader 320 receives the return signal R from the RFID tag 300. The return signal R generally includes the UID related to the RFID tag 300. The UID is a smart label encoding digital data. For example, the UID may be derived from a serial number, a date and/or time of production, an inventory number, a batch number, a model number, or a binary code related to the sewer cleanout cap 100. UID retrieval may be used to identify a particular instance of a sewer cleanout cap 100. For example, when recall is announced, the user A may scan the UID for the batch number to determine whether the sewer cleanout cap 100 is defective and/or whether a replacement is needed. The UID is generally linked to a database entry in the database 350 of the RFID reader 320. The database 350 may use the UID to obtain additional information relating to the sewer drain cleanout 10, including: installation date(s) of the sewer cleanout cap 100, cleanout and maintenance history, and/or a location of the sewer drain cleanout 10. This information may be transmitted to the display 322 on the RFID reader 320. The RFID reader 320 may be configured to modify the displayed information and/or enter additional information. Where the UID is not permanently burned into the RFID tag 300, the RFID reader 320 may be configured to reprogram the UID of the RFID tag 300 and/or additional information stored thereon. For example, if a sewer cleanout cap 100 is replaced, the RFID tag 300 can be repurposed and modified for a new sewer cleanout cap 100. The RFID tag 300 may also be encrypted for security purposes.

At step 706, the user A may determine whether to perform a maintenance action, and/or which specific maintenance action to perform, based on information from the database 350 displayed on the RFID reader 320 following the return signal R. For example, the user A may observe a potential clog through the window 110 and review the cleanout and maintenance history of the sewer drain cleanout 10. After reviewing the cleanout and maintenance history, the user A may determine any required maintenance, such as removing sewage or snaking a clogged pipe in the sewer drain cleanout 10.

It should be understood that the foregoing description is only illustrative of the present disclosure. Various alternatives, modifications, and variances can be devised by those skilled in the art without departing from the disclosure. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in any appropriately detailed structure. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A sewer cleanout cap comprising:
a body portion configured to be disposed on a sewer drain cleanout;
a window plug removably coupled to the body portion, the window plug configured to enable a user to check sewer drainage; and
a radio-frequency identification (RFID) tag configured to transmit a return signal when energized, the RFID tag disposed on the body portion.

2. The sewer cleanout cap of claim 1, wherein the RFID tag stores a unique identifier (UID), the UID enabling access to information relating to the sewer drain cleanout.

3. The sewer cleanout cap of claim 2, wherein the information relating to the sewer drain cleanout includes an installation date of the sewer cleanout cap, a cleanout and maintenance history, and/or a location.

4. The sewer cleanout cap of claim 1, wherein the body portion is comprised of at least one of lead or cast iron.

5. The sewer cleanout cap of claim 1, wherein the body portion includes threads.

6. The sewer cleanout cap of claim 1, wherein the window plug is formed in the body portion.

7. The sewer cleanout cap of claim 1, wherein the window plug includes a window to enable visibility and/or access into the sewer drain cleanout, and wherein the window is comprised of glass.

8. The sewer cleanout cap of claim 1, wherein the window plug includes a gasket to seal any gaps between the sewer cleanout cap and the sewer drain cleanout.

9. A computer-implemented method for using a sewer cleanout cap comprising:
generating an energizing signal for a radio-frequency identification (RFID) tag by an RFID reader, the RFID tag disposed on a body portion of the sewer cleanout cap, wherein the sewer cleanout cap is coupled to a sewer drain cleanout;
receiving a return signal from the RFID tag by the RFID reader; and
determining a maintenance action for a sewer drain cleanout based on the return signal.

10. The computer-implemented method of claim 9, wherein the RFID tag stores a unique identifier (UID), the UID enabling access to information relating to a sewer drain cleanout.

11. The computer-implemented method of claim 10, wherein the information relating to the sewer drain cleanout includes an installation date of the sewer cleanout cap, a cleanout and maintenance history, and/or a location.

12. The computer-implemented method of claim 10, further comprising:
reprogramming the UID of the RFID tag.

13. The computer-implemented method of claim 9, wherein the maintenance action is performed without removing the sewer cleanout cap.

14. The computer-implemented method of claim 9, further comprising:
transmitting information to a display of the RFID reader to display information relating to the RFID tag; and
modifying the displayed information via the RFID reader.

15. The computer-implemented method of claim 14, wherein the RFID reader is a mobile device.

16. A system for using a sewer cleanout cap, comprising:
a body portion configured to be disposed on a sewer drain cleanout;
a window plug removably coupled to the body portion, the window plug configured to enable a user to check sewer drainage; and
a radio-frequency identification (RFID) tag configured to transmit a return signal when energized, the RFID tag disposed on the body portion;
a processor; and
a memory storing instructions which, when executed by the processor, cause the system to:
generate an energizing signal for the RFID tag by an RFID reader, the RFID tag disposed on the body portion of the sewer cleanout cap, wherein the sewer cleanout cap is coupled to a sewer drain cleanout;
receive the return signal from the RFID tag by the RFID reader; and
determine a maintenance action for a sewer drain cleanout based on the return signal.

17. The system of claim 16, wherein the RFID tag stores a unique identifier (UID), the UID enabling access to information relating to the sewer drain cleanout.

18. The system of claim 17, wherein the instructions when executed further cause the system to:
reprogram the UID of the RFID tag.

19. The system of claim 16, wherein the maintenance action may be performed without removing the sewer cleanout cap.

20. The system of claim 16, wherein the instructions when executed further cause the system to:
transmit information to a display of the RFID reader to display information relating to the RFID tag; and
modify the displayed information via the RFID reader.
